(19) United States
(12) Patent Application Publication
(10) Pub. No.: US 2011/0066648 A1
(43) Pub. Date: Mar. 17, 2011

(54) SIMULTANEOUS RESERVATION OF BRAND IDENTITY

(76) Inventors: Raj Vasant Abhyanker, Cupertino, CA (US); Dongxia Liu, Mill Creek, WA (US)

(21) Appl. No.: 12/881,696

(22) Filed: Sep. 14, 2010

Related U.S. Application Data
(60) Provisional application No. 61/241,971, filed on Sep. 14, 2009.
(60) Provisional application No. 61/241,973, filed on Sep. 14, 2009.

(51) Int. Cl. G06F 17/30

(52) U.S. Cl. 707/770; 707/E17.014; 707/E17.107

(57) ABSTRACT

Simultaneous reservation of brand identity is disclosed. In one embodiment a method to simultaneous reserve online brand identity includes initiating a simultaneous search responsive to a single criteria, creating a uniform search result of available internet property such as trademark names, domain names, and/or social media names, searching availability of the internet property related to single search criteria, retaining ownership of matching internet property, registering the internet property, presenting opportunity to users to challenge ownership of the internet property. In another embodiment, a method may include abandoned trademarks responsive to a single search criteria are automatically registered and semantic analysis is performed on search results from the single search criteria.

### CLAIM OF PRIORITY

This application claims priority from the following:
U.S. Provisional application No. 61/241,971 titled “METHOD AND SYSTEM OF AUTOMATED DETECTION OF COUNTERFEITERS OF BRANDS” filed on Sep. 14, 2009.
U.S. Provisional application No. 61/241,973 titled “METHOD AND SYSTEM OF AUTOMATED DETERMINATION OF AVAILABILITY OF EXPIRED TRADEMARKS” filed on Sep. 14, 2009.

### FIELD OF TECHNOLOGY

This disclosure relates generally to a field of software technology and associated hardware, and more particularly to a method and system of automated determination of availability of expired trademarks including business names, slogans, and logos; method and system of automated detection of counterfeiters of brands.

### BRIEF DESCRIPTION OF THE DRAWINGS

FIG. 1 describes the simultaneous search and reserve view showing the online property search modules as well as the operation of the simultaneous registration server.

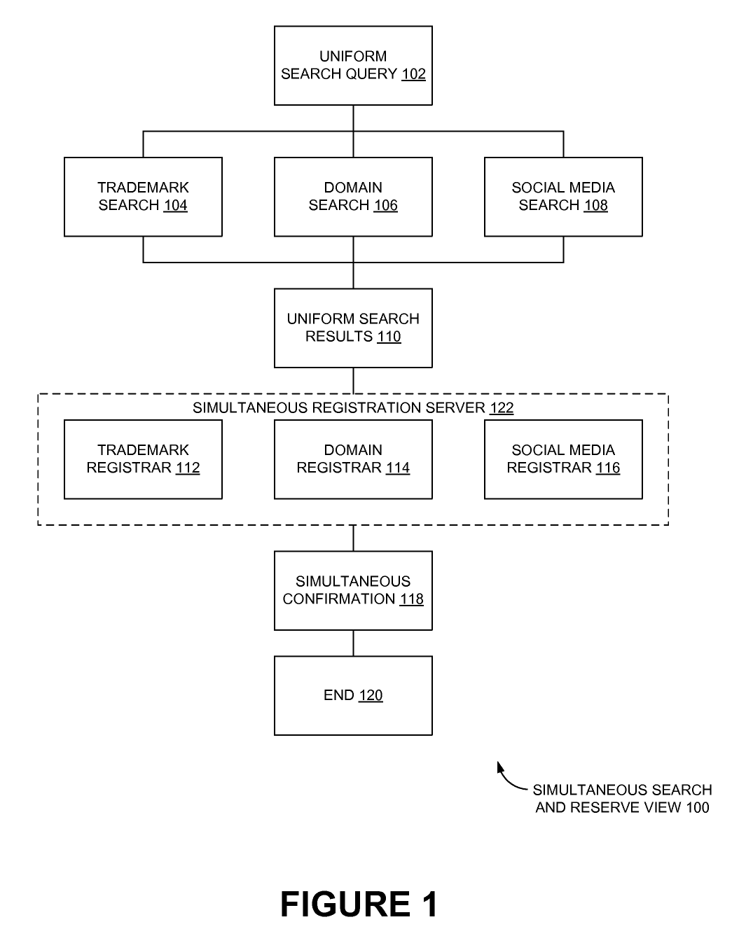

FIG. 2 is a network view that describes the operation of the trademark registrar, domain registrar and the social media registrar in relation to a user, web server, and the simultaneous registration server.

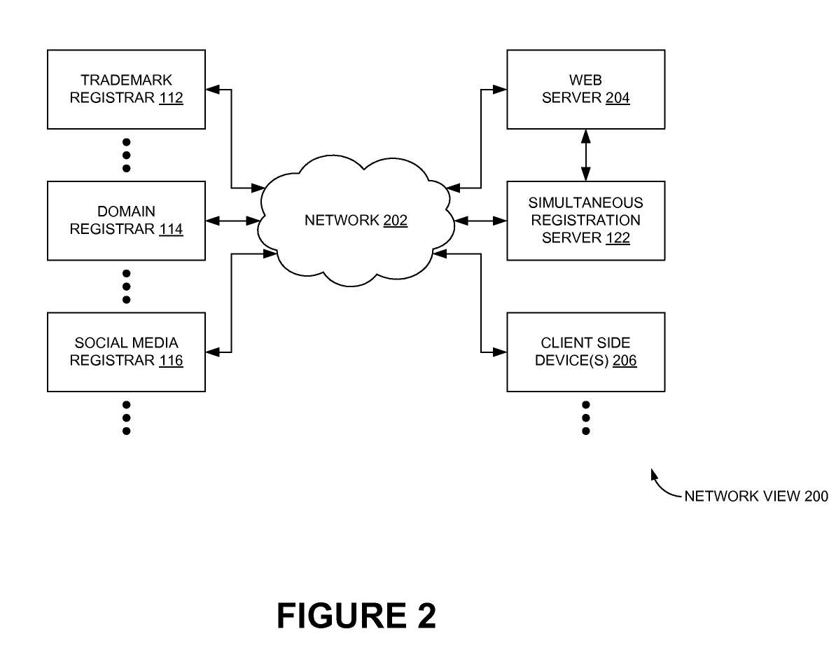

FIG. 3 is a server view that describes the workings of the different modules of the simultaneous registration server.

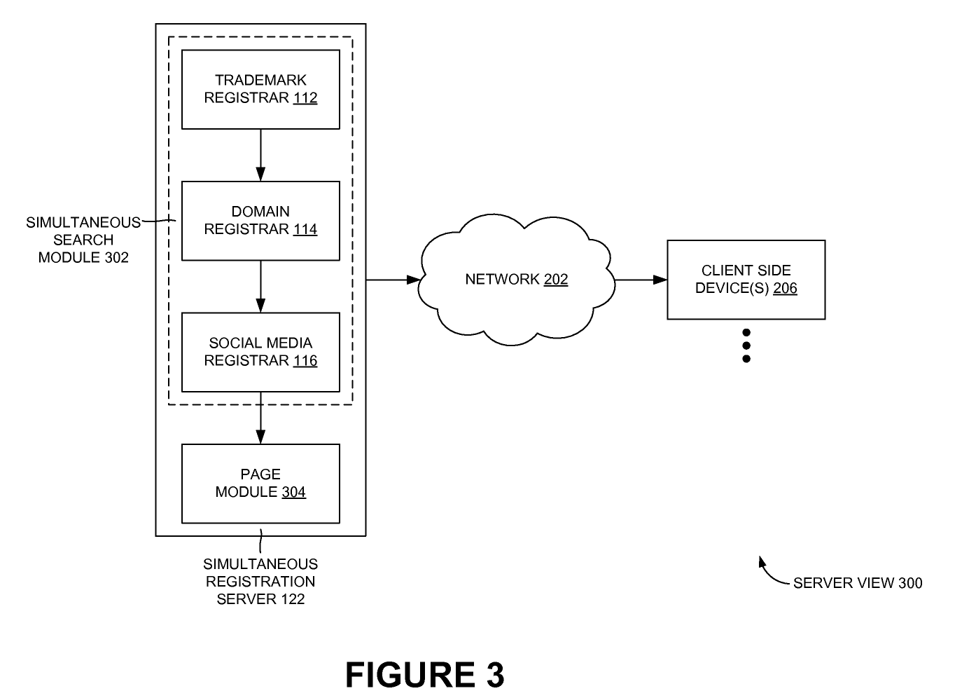

FIG. 4 is a process flow that describes the different steps to simultaneous reserve one's brand identity in an online space.

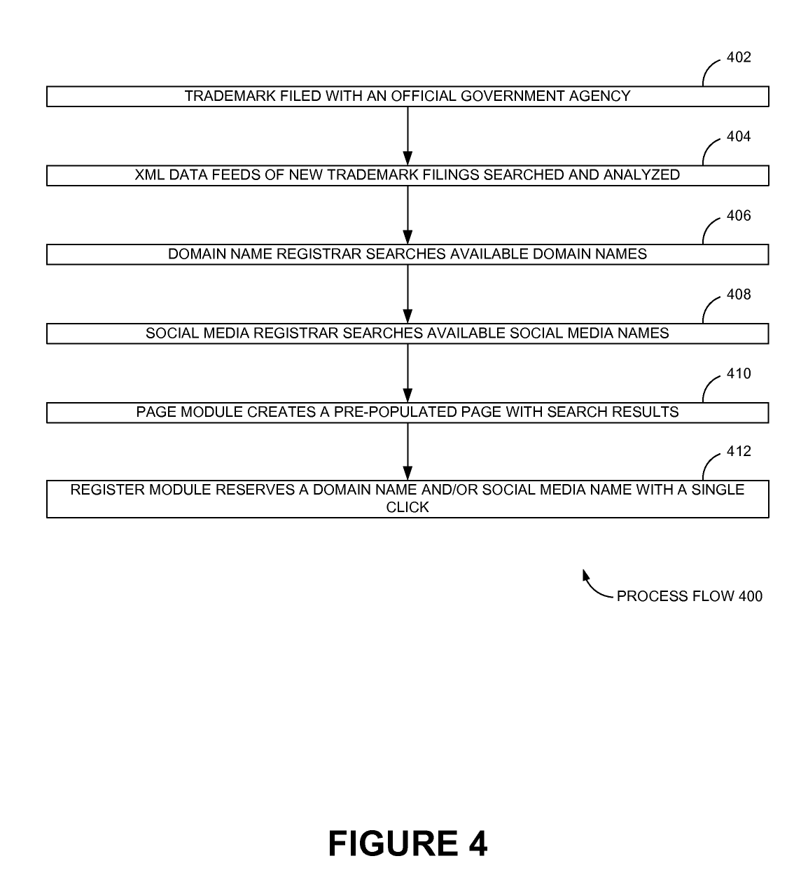

FIG. 5 is a screen shot view that shows how the simultaneous registration server operates from a user's screen view perspective.

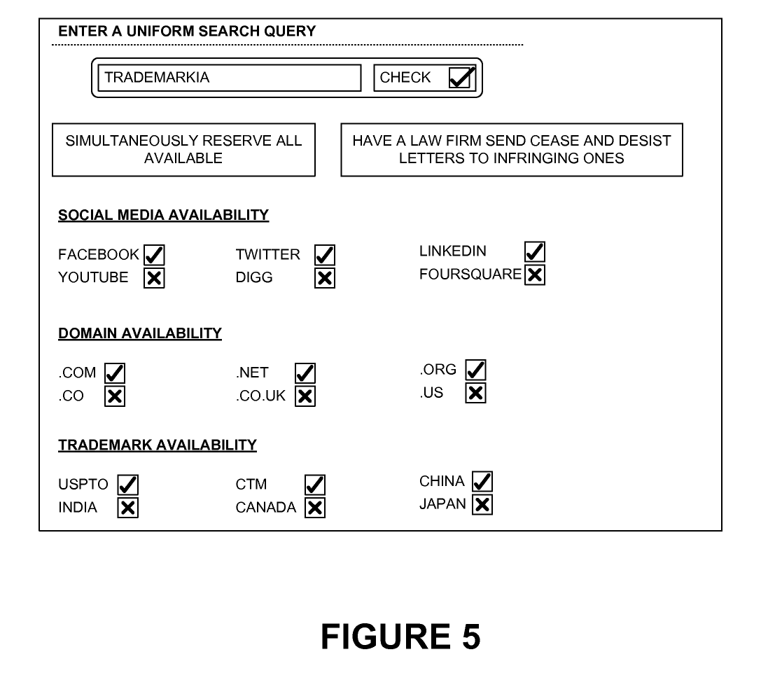

FIG. 6 is a generic computer perspective figure.

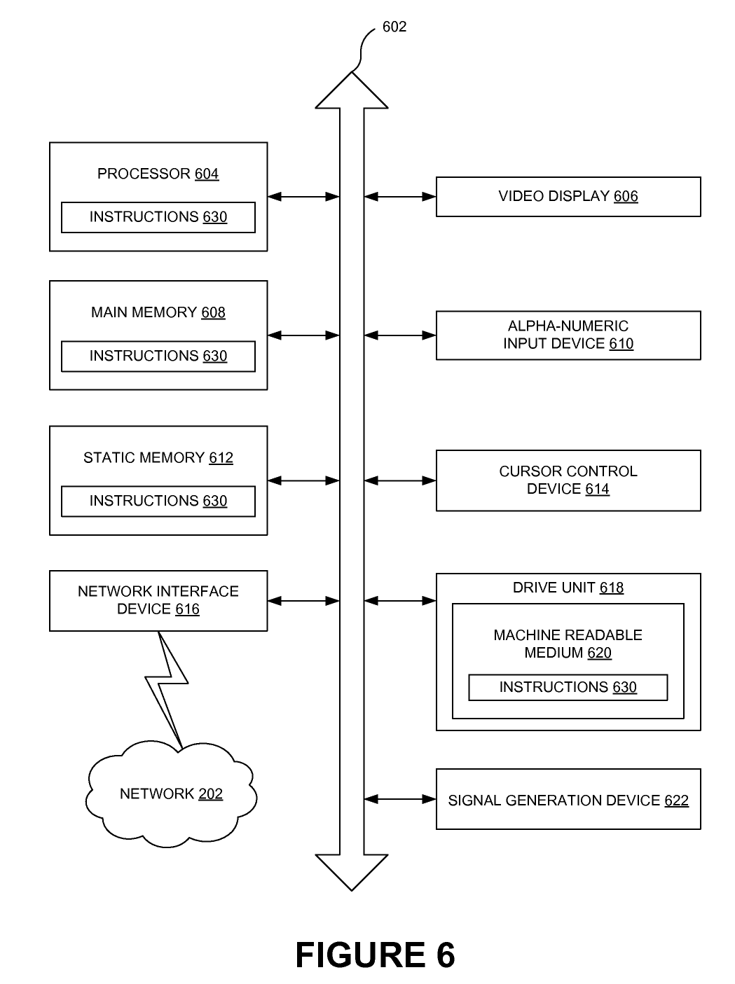

### DETAILED DESCRIPTION

A counterfeit product is an imitation which infringes upon a production monopoly held by either a state or corporation. Goods are produced with the intent to bypass this monopoly and thus take advantage of the established worth of the previous product. The word counterfeit frequently describes both the forgeries of currency and documents, as well as the imitations of clothing, software, pharmaceuticals, watches, electronics, and company logos and brands. In the case of goods it results in patent infringement or trademark infringement.

The spread of counterfeit goods (commonly called “knockoffs”) has become global in recent years and the range of goods subject to infringement has increased significantly. According to the study of Counterfeiting Intelligence Bureau (CIB) of the International Chamber of Commerce (ICC) counterfeit Goods make up 5 to 7% of World Trade, however, these figures cannot be substantiated. According to the International Anti-Counterfeiting Coalition if the knockoff economy were a business, it would be the world's biggest. A recent report by the Organisation for Economic Co-operation and Development indicates that up to 200 Billion U.S. Dollars of international trade could have been in counterfeit and illegally-copied goods in 2005 (2% of World Trade in 2005)

Some see the rise in counterfeiting of goods as an inevitable product of globalization. As more and more companies, in an effort to increase profits, move manufacturing to the cheaper labor markets of the third world, areas with weaker labor laws or environmental regulations, they give the means of production to foreign workers. These new managers of production have little or no loyalty to the original corporation. They see that profits are being made by the global brand for doing little (other than advertising) and see the possibilities of removing the middle men (i.e. the parent corporation) and marketing directly to the consumer.

Certain consumer goods, especially very expensive or desirable brands or those which are easy to reproduce cheaply have become frequent and common targets of counterfeiting. The counterfeiters either attempt to deceive the consumer into thinking they are purchasing a legitimate item, or convince the consumer that they could deceive others with the imitation. An item which doesn't attempt to deceive, such as a copy of a DVD with missing or different cover art, is often called a “bootleg” or a “pirated copy” instead.

Some counterfeits are produced in the same factory that produces the original, authentic product, using the same materials. The factory owner, unbeknownst to the trademark owner, orders an intentional ‘overrun’. Without the employment of anti-counterfeiting measures, identical manufacturing methods and materials make this type of counterfeit (and it is still a form of counterfeit, as its production and sale is unauthorized by the trademark owner) impossible to distinguish from the authentic article.

To try to avoid this, companies may have the various parts of an item manufactured in independent factories and then limit the supply of certain distinguishing parts to the factory that performs the final assembly to the exact number required for the number of items to be assembled (or as near to that number as is practicable) and/or may require the factory to account for every part used and to return any unused, faulty, or damaged parts. To help distinguish the originals from the counterfeits, the trademark holder may also employ the use of serial numbers and/or holograms etc., which may be attached to the product in another factory still.

Detection of counterfeit business names, slogans, and logos has required the assistance of expensive professionals such as marketing managers, brand experts, and trademark attorneys. Companies have not had an effective way to monitor their brands in an entirely globalizing world in which the counterfeiters can both create and market goods and services to consumers. Small company's have not had the resources to combat counterfeiters because they have not had the dedicated staff, expenses, and financial resources to employ monitoring services. Trademarkia.com has developed a unique methodology and algorithm to identify and flag counterfeiters to brands, both those of small companies and those of large companies, and offer these services to consumers through the World Wide Web for free.

The Trademarkia algorithm to identify counterfeit brands uses a multi-tier approach by employing a series of computer processors, each independently monitoring government filings in both state and federal domestic and international offices as well as active registrations of new domain names, websites, and indexed content on major search engines. By concatenating this information into one portal and using a n-tier development architecture, the concatenated data can be matched against and active or passive user request in a profile of the user.

A semantic database can be used to match the search term with other names/marks/slogans which might be confusingly similar. A match and count may be generated by cross referencing a potential mark on Twitter/Google to determine the search criteria's mark fame. This can help determine whether a likelihood of confusion or dilution test is to be used. Furthermore, a number of alternative techniques may be employed by allowing a simultaneous generation of possibly conflicting marks when a new mark is filed (e.g., either as a refilling of an abandoned trademark offered in a search result) or as an independent new filing.

In addition, opposition service windows may be adhered to by allowing users to find and oppose marks that are confusingly similar to theirs. Automated messages are sent through the system to address such conflicting marks to users so that they may oppose them electronically directly though the Trademarkia system according to one embodiment. As a result, the system and methods disclosed herein simplify the opposition processes. For example, an opposition may be enabled as a proceeding in which one party is seeking to prevent registration of another party's trademark when a user clicks an ‘oppose’ button accessible through a link in an electronic message submitted to a user through Trademarkia.

The Figures that this disclosure contemplates include a system view of a computing device, according to one or more embodiments. In one or more embodiments, a computing device may include a display unit and a display driver associated with the display unit that performs the methods disclosed herein of automatically detecting counterfeit brands.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Accordingly, the specification and drawings are to be regarded in an illustrative rather than a restrictive sense.

A brand is a name or trademark connected with a product or producer. Brands have become increasingly important components of culture and the economy, now being described as “cultural accessories and personal philosophies”. However, there has till now been no way to effectively search for and reapply for existing brands.

Some people distinguish the psychological aspect of a brand from the experiential aspect. The experiential aspect consists of the sum of all points of contact with the brand and is known as the brand experience. The psychological aspect, sometimes referred to as the brand image, is a symbolic construct created within the minds of people and consists of all the information and expectations associated with a product or service.

People engaged in branding seek to develop or align the expectations behind the brand experience, creating the impression that a brand associated with a product or service has certain qualities or characteristics that make it special or unique. A brand is therefore one of the most valuable elements in an advertising theme, as it demonstrates what the brand owner is able to offer in the marketplace. The art of creating and maintaining a brand is called brand management. Orientation of the whole Organisation towards its brand is called integrated marketing.

Careful brand management, supported by a cleverly crafted advertising campaign, can be highly successful in convincing consumers to pay remarkably high prices for products which are inherently extremely cheap to make. This concept, known as creating value, essentially consists of manipulating the projected image of the product so that the consumer sees the product as being worth the amount that the advertiser wants him/her to see, rather than a more logical valuation that comprises an aggregate of the cost of raw materials, plus the cost of manufacture, plus the cost of distribution. Modern value-creation branding-and-advertising campaigns are highly successful at inducing consumers to pay, for example, 50 dollars for a T-shirt that cost a mere 50 cents to make, or 5 dollars for a box of breakfast cereal that contains a few cents' worth of wheat.

Brands should be seen as more than the difference between the actual cost of a product and its selling price—they represent the sum of all valuable qualities of a product to the consumer. There are many intangibles involved in business, intangibles left wholly from the income statement and balance sheet which determine how a business is perceived. The learned skill of a knowledge worker, the type of metal working, the type of stitch: all may be without an ‘accounting cost’ but for those who truly know the product, for it is these people the company should wish to find and keep, the difference is incomparable. By failing to recognize these assets that a business, any business, can create and maintain will set an enterprise at a serious disadvantage.

A brand which is widely known in the marketplace acquires brand recognition. When brand recognition builds up to a point where a brand enjoys a critical mass of positive sentiment in the marketplace, it is said to have achieved brand franchise. One goal in brand recognition is the identification of a brand without the name of the company present. For example, Disney has been successful at branding with their particular script font (originally created for Walt Disney's “signature” logo), which it used in the logo for go.com.

Consumers may look on branding as an important value added aspect of products or services, as it often serves to denote a certain attractive quality or characteristic (see also brand promise). From the perspective of brand owners, branded products or services also command higher prices. Where two products resemble each other, but one of the products has no associated branding (such as a generic, store-branded product), people may often select the more expensive branded product on the basis of the quality of the brand or the reputation of the brand owner.

The brand name is often used interchangeably within “brand”, although it is more correctly used to specifically denote written or spoken linguistic elements of any product. In this context a “brand name” constitutes a type of trademark, if the brand name exclusively identifies the brand owner as the commercial source of products or services. A brand owner may seek to protect proprietary rights in relation to a brand name through trademark registration. Advertising spokespersons have also become part of some brands, for example: Mr. Whipple of Charmin toilet tissue and Tony the Tiger of Kellogg's.

Descriptive brand names assist in describing the distinguishable selling point(s) of the product to the customer (e.g. Snap, Crackle and Pop or Bitter Lemon).

Associative brand names provide the customer with an associated word for what the product promises to do or be (e.g. Walkman, Sensodyne or Natrel)

Finally, freestanding brand names have no links or ties to either descriptions or associations of use. (e.g. Mars Bar or Pantene)

The act of associating a product or service with a brand has become part of pop culture. Most products have some kind of brand identity, from common table salt to designer jeans. A brandnomer is a brand name that has colloquially become a generic term for a product or service, such as Band-Aid or Kleenex, which are often used to describe any kind of adhesive bandage or any kind of facial tissue respectively.

A product identity, or brand image are typically the attributes one associates with a brand, how the brand owner wants the consumer to perceive the brand—and by extension the branded company, organization, product or service. The brand owner will seek to bridge the gap between the brand image and the brand identity. Effective brand names build a connection between the brand personality as it is perceived by the target audience and the actual product/service. The brand name should be conceptually on target with the product/service (what the company stands for). Furthermore, the brand name should be on target with the brand demographic. Typically, sustainable brand names are easy to remember, transcend trends and have positive connotations. Brand identity is fundamental to consumer recognition and symbolizes the brand's differentiation from competitors.

Brand identity is what the owner wants to communicate to its potential consumers. However, over time, a products brand identity may acquire (evolve), gaining new attributes from consumer perspective but not necessarily from the marketing communications an owner percolates to targeted consumers. Therefore, brand associations become handy to check the consumer's perception of the brand.

Brand identity needs to focused on authentic qualities—real characteristics of the value and brand promise being provided and sustained by Organisational and/or production characteristics. Managing the whole organisation to this purpose is called Integrated Marketing.

Often, especially in the industrial sector, it is just the company's name which is promoted (leading to one of the most powerful statements of “branding”; the saying, before the company's downgrading, “No one ever got fired for buying IBM”).

In this case a very strong brand name (or company name) is made the vehicle for a range of products (for example, Mercedes-Benz or Black & Decker) or even a range of subsidiary brands (such as Cadbury Dairy Milk, Cadbury Flake or Cadbury Fingers in the United States).

Each brand has a separate name (such as Seven-Up or Nivea Sun (Beiersdorf)), which may even compete against other brands from the same company (for example, Persil, Omo, Surf and Lynx are all owned by Unilever).

Attitude branding is the choice to represent a larger feeling, which is not necessarily connected with the product or consumption of the product at all. Marketing labeled as attitude branding include that of Nike, Starbucks, The Body Shop, Safeway, and Apple Computer. In the 2000 book No Logo, Naomi Klein describes attitude branding as a “fetish strategy”.

“A great brand raises the bar—it adds a greater sense of purpose to the experience, whether it's the challenge to do your best in sports and fitness, or the affirmation that the cup of coffee you're drinking really matters.”—Howard Schultz (president, CEO, and chairman of Starbucks)

Iconic brands are defined as having aspects that contribute to consumer's self-expression and personal identity. Brands whose value to consumers comes primarily from having identity value comes are said to be “identity brands”. Some of these brands have such a strong identity that they become more or less “cultural icons” which makes them iconic brands. Examples of iconic brands are: Apple Computer, Nike and Harley Davidson. Many iconic brands include almost ritual-like behaviour when buying and consuming the products.

There are four key elements to creating iconic brands (Holt 2004): 1. “Necessary conditions”—The performance of the product must at least be ok preferably with a reputation of having good quality. 2. “Myth-making”—A meaningful story-telling fabricated by cultural “insiders”. These must be seen as legitimate and respected by consumers for stories to be accepted. 3. “Cultural contradictions”—Some kind of mismatch between prevailing ideology and emergent undercurrents in society. In other words a difference with the way consumers are and how they some times wish they were. 4. “The cultural brand management process”—Actively engaging in the myth-making process making sure the brand maintains its position as an icon.

Recently a number of companies have successfully pursued “No-Brand” strategies, examples include the Japanese company Muji, which means “No label” in English (from [symbol] —“Mujirushi Ryohin”—literally, “No brand quality goods”). Although there is a distinct Muji brand, Muji products are not branded. This no-brand strategy means that little is spent on advertisement or classical marketing and Muji's success is attributed to the word-of-mouth, a simple shopping experience and the anti-brand movement.

In this case the supplier of a key component, used by a number of suppliers of the end-product, may wish to guarantee its own position by promoting that component as a brand in its own right. The most frequently quoted example is Intel, which secures its position in the PC market with the slogan “Intel Inside”.

The existing strong brand name can be used as a vehicle for new or modified products; for example, many fashion and designer companies extended brands into fragrances, shoes and accessories, home textile, home decor, luggage, (sun-) glasses, furniture, hotels, etc.

Mars extended its brand to ice cream, Caterpillar to shoes and watches, Michelin to a restaurant guide, Adidas and Puma to personal hygiene. Dunlop extended its brand from tires to other rubber products such as shoes, golf balls, tennis racquets and adhesives.

There is a difference between brand extension and line extension. When Coca-Cola launched “Diet Coke” and “Cherry Coke” they stayed within the originating product category: non-alcoholic carbonated beverages. Procter & Gamble (P&G) did likewise extending its strong lines (such as Fairy Soap) into neighboring products (Fairy Liquid and Fairy Automatic) within the same category, dish washing detergents.

Alternatively, in a market that is fragmented amongst a number of brands a supplier can choose deliberately to launch totally new brands in apparent competition with its own existing strong brand (and often with identical product characteristics); simply to soak up some of the share of the market which will in any case go to minor brands. The rationale is that having 3 out of 12 brands in such a market will give a greater overall share than having 1 out of 10 (even if much of the share of these new brands is taken from the existing one). In its most extreme manifestation, a supplier pioneering a new market which it believes will be particularly attractive may choose immediately to launch a second brand in competition with its first, in order to pre-empt others entering the market.

Individual brand names naturally allow greater flexibility by permitting a variety of different products, of differing quality, to be sold without confusing the consumer's perception of what business the company is in or diluting higher quality products.

Once again, Procter & Gamble is a leading exponent of this philosophy, running as many as ten detergent brands in the US market. This also increases the total number of “facings” it receives on supermarket shelves. Sara Lee, on the other hand, uses it to keep the very different parts of the business separate—from Sara Lee cakes through Kiwi polishes to L'Eggs pantyhose. In the hotel business, Marriott uses the name Fairfield Inns for its budget chain (and Ramada uses Rodeway for its own cheaper hotels).

Cannibalization is a particular problem of a “multibrand” approach, in which the new brand takes business away from an established one which the organization also owns. This may be acceptable (indeed to be expected) if there is a net gain overall. Alternatively, it may be the price the organization is willing to pay for shifting its position in the market; the new product being one stage in this process.

With the emergence of strong retailers the “own brand”, a retailer's own branded product (or service), also emerged as a major factor in the marketplace. Where the retailer has a particularly strong identity (such as Marks & Spencer in the UK clothing sector) this “own brand” may be able to compete against even the strongest brand leaders, and may outperform those products that are not otherwise strongly branded.

Concerns were raised that such “own brands” might displace all other brands (as they have done in Marks & Spencer outlets), but the evidence is that—at least in supermarkets and department stores—consumers generally expect to see on display something over 50 percent (and preferably over 60 percent) of brands other than those of the retailer. Indeed, even the strongest own brands in the UK rarely achieve better than third place in the overall market.

This means that strong independent brands (such as Kellogg's and Heinz), which have maintained their marketing investments, are likely to continue their strong performance. More than 50 percent of UK FMCG brand leaders have held their position for more than two decades, although it is arguable that those which have switched their budgets to “buy space” in the retailers may be more exposed.

The strength of the retailers has, perhaps, been seen more in the pressure they have been able to exert on the owners of even the strongest brands (and in particular on the owners of the weaker third and fourth brands). Relationship marketing has been applied most often to meet the wishes of such large customers (and indeed has been demanded by them as recognition of their buying power). Some of the more active marketers have now also switched to ‘category marketing’—in which they take into account all the needs of a retailer in a product category rather than more narrowly focusing on their own brand.

At the same time, probably as an outgrowth of consumerism, “generic” (that is, effectively unbranded) goods have also emerged. These made a positive virtue of saving the cost of almost all marketing activities; emphasizing the lack of advertising and, especially, the plain packaging (which was, however, often simply a vehicle for a different kind of image). It would appear that the penetration of such generic products peaked in the early 1980s, and most consumers still appear to be looking for the qualities that the conventional brand provides.

Although connected with the history of trademarks and including earlier examples which could be deemed “protobrands” (such as the marketing puns of the “Vesuvinum” wine jars found at Pompeii), brands in the field of mass-marketing originated in the 19th century with the advent of packaged goods. Industrialization moved the production of many household items, such as soap, from local communities to centralized factories. When shipping their items, the factories would literally brand their logo or insignia on the barrels used, extending the meaning of “brand” to that of trademark.

Bass & Company, the British brewery, claims their red triangle brand was the world's first trademark. Lyle's Golden Syrup makes a similar claim, having been named as Britain's oldest brand, with its green and gold packaging having remained almost unchanged since 1885.

Cattle were branded long before this; the term “maverick”, originally meaning an unbranded calf, comes from Texas rancher Samuel Augustus Maverick who, following the American Civil War, decided that since all other cattle were branded, his would be identified by having no markings at all.

Factories established during the Industrial Revolution, generating mass-produced goods and needed to sell their products to a wider market, to a customer base familiar only with local goods. It quickly became apparent that a generic package of soap had difficulty competing with familiar, local products. The packaged goods manufacturers needed to convince the market that the public could place just as much trust in the non-local product. Campbell soup, Coca-Cola, Juicy Fruit gum, Aunt Jemima, and Quaker Oats were among the first products to be ‘branded’, in an effort to increase the consumer's familiarity with their products. Many brands of that era, such as Uncle Ben's rice and Kellogg's breakfast cereal furnish illustrations of the problem.

Around 1900, James Walter Thompson published a house ad explaining trademark advertising. This was an early commercial explanation of what we now know as branding. Companies soon adopted slogans, mascots, and jingles which began to appear on radio and early television. By the 1940s, manufacturers began to recognize the way in which consumers were developing relationships with their brands in a social/psychological/anthropological sense.

From there, manufacturers quickly learned to build their brand's identity and personality (see brand identity and brand personality), such as youthfulness, fun or luxury. This began the practice we now know as “branding” today, where the consumers buy “the brand” instead of the product. This trend continued to the 1980s, and is now quantified in concepts such as brand value and brand equity. Naomi Klein has described this development as “brand equity mania”. In 1988, for example, Philip Morris purchased Kraft for six times what the company was worth on paper; it was felt that what they really purchased was its brand name.

Marlboro Friday: Apr. 2, 1993—marked by some as the death of the brand—the day Philip Morris declared that they were to cut the price of Marlboro cigarettes by 20%, in order to compete with bargain cigarettes. Marlboro cigarettes were notorious at the time for their heavy advertising campaigns, and well-nuanced brand image. In response to the announcement Wall street stocks nose-dived for a large number of ‘branded’ companies: Heinz, Coca Cola, Quaker Oats, PepsiCo. Many thought the event signalled the beginning of a trend towards “brand blindness” (Klein 13), questioning the power of “brand value”.

A trademark or trademark is a distinctive sign or indicator used by an individual, business organization, or other legal entity to identify that the products or services to consumers with which the trademark appears originate from a unique source, and to distinguish its products or services from those of other entities.

A trademark is a type of intellectual property, and typically a name, word, phrase, logo, symbol, design, image, or a combination of these elements. There is also a range of non-conventional trademarks comprising marks which do not fall into these standard categories.

The owner of a registered trademark may commence legal proceedings for trademark infringement to prevent unauthorized use of that trademark. However, registration is not required. The owner of a common law trademark may also file suit, but an unregistered mark may be protectable only within the geographical area within which it has been used or in geographical areas into which it may be reasonably expected to expand.

The term trademark is also used informally to refer to any distinguishing attribute by which an individual is readily identified, such as the well known characteristics of celebrities. When a trademark is used in relation to services rather than products, it may sometimes be called a service mark, particularly in the United States.

A counterfeit product is an imitation which infringes upon a production monopoly held by either a state or corporation. Goods are produced with the intent to bypass this monopoly and thus take advantage of the established worth of the previous product. The word counterfeit frequently describes both the forgeries of currency and documents, as well as the imitations of clothing, software, pharmaceuticals, watches, electronics, and company logos and brands. In the case of goods it results in patent infringement or trademark infringement.

The spread of counterfeit goods (commonly called “knockoffs”) has become global in recent years and the range of goods subject to infringement has increased significantly. According to the study of Counterfeiting Intelligence Bureau (CIB) of the International Chamber of Commerce (ICC) counterfeit Goods make up 5 to 7% of World Trade, however, these figures cannot be substantiated. According to the International Anti-Counterfeiting Coalition if the knockoff economy were a business, it would be the world's biggest. A recent report by the Organisation for Economic Co-operation and Development indicates that up to 200 Billion U.S. Dollars of international trade could have been in counterfeit and illegally-copied goods in 2005 (2% of World Trade in 2005).

Some see the rise in counterfeiting of goods as an inevitable product of globalization. As more and more companies, in an effort to increase profits, move manufacturing to the cheaper labor markets of the third world, areas with weaker labor laws or environmental regulations, they give the means of production to foreign workers. These new managers of production have little or no loyalty to the original corporation. They see that profits are being made by the global brand for doing little (other than advertising) and see the possibilities of removing the middle men (i.e. the parent corporation) and marketing directly to the consumer.

Certain consumer goods, especially very expensive or desirable brands or those which are easy to reproduce cheaply have become frequent and common targets of counterfeiting. The counterfeiters either attempt to deceive the consumer into thinking they are purchasing a legitimate item, or convince the consumer that they could deceive others with the imitation. An item which doesn't attempt to deceive, such as a copy of a DVD with missing or different cover art, is often called a “bootleg” or a “pirated copy” instead.

Some counterfeits are produced in the same factory that produces the original, authentic product, using the same materials. The factory owner, unbeknownst to the trademark owner, orders an intentional ‘overrun’. Without the employment of anti-counterfeiting measures, identical manufacturing methods and materials make this type of counterfeit (and it is still a form of counterfeit, as its production and sale is unauthorized by the trademark owner) impossible to distinguish from the authentic article.

To try to avoid this, companies may have the various parts of an item manufactured in independent factories and then limit the supply of certain distinguishing parts to the factory that performs the final assembly to the exact number required for the number of items to be assembled (or as near to that number as is practicable) and/or may require the factory to account for every part used and to return any unused, faulty, or damaged parts. To help distinguish the originals from the counterfeits, the trademark holder may also employ the use of serial numbers and/or holograms etc., which may be attached to the product in another factory still.

Detection of counterfeit business names, slogans, and logos has required the assistance of expensive professionals such as marketing managers, brand experts, and trademark attorneys. Companies have not had an effective way to monitor their brands in an entirely globalizing world in which the counterfeiters can both create and market goods and services to consumers. Small company's have not had the resources to combat counterfeiters because they have not had the dedicated staff, expenses, and financial resources to employ monitoring services. Trademarkia.com has developed a unique methodology and algorithm to identify and flag counterfeiters to brands, both those of small companies and those of large companies, and offer these services to consumers through the World Wide Web for free.

The Trademarkia algorithm to identify counterfeit brands uses a multi-tier approach by employing a series of computer processors, each independently monitoring government filings in both state and federal domestic and international offices as well as active registrations of new domain names, websites, and indexed content on major search engines. By concatenating this information into one portal and using a n-tier development architecture, the concatenated data can be matched against and active or passive user request in a profile of the user. This may also enable interesting new search possibilities, such as the search and repurchase/reapplication of expired, abandoned, and/or otherwise no longer live trademarks by new applications. Prescreening technologies enable the system to generate unique search accuracies that build trust with users, according to one embodiment.

For example, a semantic database can be used to match the search term with other names/marks/slogans which might be confusingly similar. A match and count may be generated by cross referencing a potential mark on Twitter/Google to determine the search criteria's mark fame. This can help determine whether a likelihood of confusion or dilution test is to be used. Furthermore, a number of alternative techniques may be employed by allowing a simultaneous generation of possibly conflicting marks when a new mark is filed (e.g., either as a refilling of an abandoned trademark offered in a search result) or as an independent new filing.

In addition, opposition service windows may be adhered to by allowing users to find and oppose marks that are confusingly similar to theirs. Automated messages are sent through the system to address such conflicting marks to users so that they may oppose them electronically directly though the Trademarkia system according to one embodiment. As a result, the system and methods disclosed herein simplify the opposition processes. For example, an opposition may be enabled as a proceeding in which one party is seeking to prevent registration of another party's trademark when a user clicks an ‘oppose’ button accessible through a link in an electronic message submitted to a user through Trademarkia.

Trademarkia Previews Freshest, Easiest Way to Create a Brand at TechCrunch50. And it's Free. More than 5 million new logos, slogans, and trademarks searchable on Web for the First Time (www.trademarkia.com), the fresh, easy and intelligent way for people to create a brand, today previews its free service at TechCrunch50. Trademarkia was selected to demonstrate its product in TechCrunch50—a showcase of the world's hottest new startups—from among more than 1,000 applicants in 26 different countries.

Trademarkia is for busy people who want an effortless way to create a business name from the millions of trademarks filed at the United States Trademark Office that have now gone abandoned; receive email and SMS reminders and alerts on counterfeit brands; and find savings worth an average of $1,000 within minutes of use. People have really had only two ways to create a new brand in the past: come up with it on their own and hire a consultant. 6 million businesses in the U.S. need to create brands for their business, products, and services each year. Until Trademarkia, the option of creating a business name from abandoned names did not exist anywhere on the web because there was no way to find such names. Even when a good name for a brand was identified, verification of availability of a particular brand name required the assistance of expensive attorneys. What would the world be like if we couldn't “Google” information we did not already know? Such a world may have been our fate, had the prior holders of that mark not abandoned their ownership of it. Until Trademarkia, once fledging startups such as Google, Twitter, and Yelp (all previously owned brands) had to rely on expensive attorneys to find out whether previously expired brands were in fact available for purchase.

Startup entrepreneur and intellectual property attorney Raj Abhyanker considered these things when creating Trademarkia. “Trademarkia is essentially creating a market in which abandoned business names can be recycled similar to the now $1 billion+expired domain industry.” Trademarkia exposes the millions of historical business names, slogans and logos since the year 1870 that have now gone abandoned and makes them available for re-registration.

Trademarkia is the free, easy and intelligent way to create and manage brands online

Trademarkia is designed to be virtually effortless for the user. It applies a patent-pending technology and proprietary algorithms to compile business name data from all available sources into a single, easy-to-use and uniquely powerful online business name search engine. In addition, Trademarkia also offers a valuable service to businesses looking to protect the brands they already own. Trademarkia enables businesses, both large and small, to keep an eye on their competitors who try to file trademarks, domain names, and start websites which are confusingly similar to the brands that they worked hard to build and protect. Users simply indicate the brands that they want to monitor, and can receive free online reports and updates on activities of counterfeiters.

Trademarkia.com has been in private beta testing for the past few months, and is generating highly enthusiastic responses from early users. Trademarkia's management and engineering team is comprised of experts in Web technology, brand management and intellectual property. Trademarkia's product and market potential have attracted investment interest from both the venture and angel communities. “This is a great product! It is fun to find interesting brands on Trademarkia that can help my small business succeed,” said Colette Pierre, a Trademarkia private beta user. “I recently registered my brand as a federal trademark, and it is important to the long term success of our small business to be able to monitor against companies trying to steal our goodwill. Trademarkia makes that process easy, and has already saved our company money.”

Founded in March 2009, Trademarkia.com is the fresh, easy and intelligent way for people to create their brands from millions of previously owned business names, slogans, and logos. And it's free.

Patent-pending Trademarkia technology does all the rest, giving users a unified view of all their brands in a single, easy to understand interface. Trademarkia provides detailed visibility into expired and abandoned business names, slogans, and logos; proactively alerting users about upcoming issues, counterfeit marks; and offering personalized suggestions for interesting brands. The service is accessible via the Web or cell phone. And it's safe and secure; Trademarkia is updated every day with fresh data, and offers secondary checking services to users.

For more information on Trademarkia.com's free business name creation service, please visit www.trademarkia.com.

The Figures that this disclosure contemplates include a system view of a computing device, according to one or more embodiments. In one or more embodiments, a computing device may include a display unit and a display driver associated with the display unit that performs the methods disclosed herein of automatically detecting counterfeit brands.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Accordingly, the specification and drawings are to be regarded in an illustrative rather than a restrictive sense.

A brand is a name or trademark connected with a product or producer. Brands have become increasingly important components of culture and the economy, now being described as “cultural accessories and personal philosophies”. However, there has till now been no way to effectively search for and reapply for existing brands.

Some people distinguish the psychological aspect of a brand from the experiential aspect. The experiential aspect consists of the sum of all points of contact with the brand and is known as the brand experience. The psychological aspect, sometimes referred to as the brand image, is a symbolic construct created within the minds of people and consists of all the information and expectations associated with a product or service.

People engaged in branding seek to develop or align the expectations behind the brand experience, creating the impression that a brand associated with a product or service has certain qualities or characteristics that make it special or unique. A brand is therefore one of the most valuable elements in an advertising theme, as it demonstrates what the brand owner is able to offer in the marketplace. The art of creating and maintaining a brand is called brand management. Orientation of the whole organisation towards its brand is called integrated marketing.

Careful brand management, supported by a cleverly crafted advertising campaign, can be highly successful in convincing consumers to pay remarkably high prices for products which are inherently extremely cheap to make. This concept, known as creating value, essentially consists of manipulating the projected image of the product so that the consumer sees the product as being worth the amount that the advertiser wants him/her to see, rather than a more logical valuation that comprises an aggregate of the cost of raw materials, plus the cost of manufacture, plus the cost of distribution. Modern value-creation branding-and-advertising campaigns are highly successful at inducing consumers to pay, for example, 50 dollars for a T-shirt that cost a mere 50 cents to make, or 5 dollars for a box of breakfast cereal that contains a few cents' worth of wheat.

Brands should be seen as more than the difference between the actual cost of a product and its selling price—they represent the sum of all valuable qualities of a product to the consumer. There are many intangibles involved in business, intangibles left wholly from the income statement and balance sheet which determine how a business is perceived. The learned skill of a knowledge worker, the type of metal working, the type of stitch: all may be without an ‘accounting cost’ but for those who truly know the product, for it is these people the company should wish to find and keep, the difference is incomparable. By failing to recognize these assets that a business, any business, can create and maintain will set an enterprise at a serious disadvantage.

A brand which is widely known in the marketplace acquires brand recognition. When brand recognition builds up to a point where a brand enjoys a critical mass of positive sentiment in the marketplace, it is said to have achieved brand franchise. One goal in brand recognition is the identification of a brand without the name of the company present. For example, Disney has been successful at branding with their particular script font (originally created for Walt Disney's “signature” logo), which it used in the logo for go.com.

Consumers may look on branding as an important value added aspect of products or services, as it often serves to denote a certain attractive quality or characteristic (see also brand promise). From the perspective of brand owners, branded products or services also command higher prices. Where two products resemble each other, but one of the products has no associated branding (such as a generic, store-branded product), people may often select the more expensive branded product on the basis of the quality of the brand or the reputation of the brand owner.

The brand name is often used interchangeably within “brand”, although it is more correctly used to specifically denote written or spoken linguistic elements of any product. In this context a “brand name” constitutes a type of trademark, if the brand name exclusively identifies the brand owner as the commercial source of products or services. A brand owner may seek to protect proprietary rights in relation to a brand name through trademark registration. Advertising spokespersons have also become part of some brands, for example: Mr. Whipple of Charmin toilet tissue and Tony the Tiger of Kellogg's.

Descriptive brand names assist in describing the distinguishable selling point(s) of the product to the customer (eg Snap, Crackle and Pop or Bitter Lemon).

Associative brand names provide the customer with an associated word for what the product promises to do or be (e.g. Walkman, Sensodyne or Natrel)

Finally, Freestanding brand names have no links or ties to either descriptions or associations of use. (eg Mars Bar or Pantene)

The act of associating a product or service with a brand has become part of pop culture. Most products have some kind of brand identity, from common table salt to designer jeans. A brandnomer is a brand name that has colloquially become a generic term for a product or service, such as Band-Aid or Kleenex, which are often used to describe any kind of adhesive bandage or any kind of facial tissue respectively.

A product identity, or brand image are typically the attributes one associates with a brand, how the brand owner wants the consumer to perceive the brand—and by extension the branded company, organization, product or service. The brand owner will seek to bridge the gap between the brand image and the brand identity.[3] Effective brand names build a connection between the brand personality as it is perceived by the target audience and the actual product/service. The brand name should be conceptually on target with the product/service (what the company stands for). Furthermore, the brand name should be on target with the brand demographic.[4] Typically, sustainable brand names are easy to remember, transcend trends and have positive connotations. Brand identity is fundamental to consumer recognition and symbolizes the brand's differentiation from competitors.

Brand identity is what the owner wants to communicate to its potential consumers. However, over time, a products brand identity may acquire (evolve), gaining new attributes from consumer perspective but not necessarily from the marketing communications an owner percolates to targeted consumers. Therefore, brand associations become handy to check the consumer's perception of the brand.[5]

Brand identity needs to focused on authentic qualities—real characteristics of the value and brand promise being provided and sustained by organisational and/or production characterstics[6], [7]. Managing the whole organisation to this purpose is called Integrated Marketing.

Often, especially in the industrial sector, it is just the company's name which is promoted (leading to one of the most powerful statements of “branding”; the saying, before the company's downgrading, “No one ever got fired for buying IBM”).

In this case a very strong brand name (or company name) is made the vehicle for a range of products (for example, Mercedes-Benz or Black & Decker) or even a range of subsidiary brands (such as Cadbury Dairy Milk, Cadbury Flake or Cadbury Fingers in the United States).

Each brand has a separate name (such as Seven-Up or Nivea Sun (Beiersdorf)), which may even compete against other brands from the same company (for example, Persil, Omo, Surf and Lynx are all owned by Unilever).

Attitude branding is the choice to represent a larger feeling, which is not necessarily connected with the product or consumption of the product at all. Marketing labeled as attitude branding include that of Nike, Starbucks, The Body Shop, Safeway, and Apple Computer. In the 2000 book No Logo[2], Naomi Klein describes attitude branding as a “fetish strategy”.

“A great brand raises the bar—it adds a greater sense of purpose to the experience, whether it's the challenge to do your best in sports and fitness, or the affirmation that the cup of coffee you're drinking really matters.”—Howard Schultz (president, CEO, and chairman of Starbucks)

Iconic brands are defined as having aspects that contribute to consumer's self-expression and personal identity. Brands whose value to consumers comes primarily from having identity value comes are said to be “identity brands”. Some of these brands have such a strong identity that they become more or less “cultural icons” which makes them iconic brands. Examples of iconic brands are: Apple Computer, Nike and Harley Davidson. Many iconic brands include almost ritual-like behaviour when buying and consuming the products.

There are four key elements to creating iconic brands (Holt 2004): 1. “Necessary conditions”—The performance of the product must at least be ok preferably with a reputation of having good quality. 2. “Myth-making”—A meaningful story-telling fabricated by cultural “insiders”. These must be seen as legitimate and respected by consumers for stories to be accepted. 3. “Cultural contradictions”—Some kind of mismatch between prevailing ideology and emergent undercurrents in society. In other words a difference with the way consumers are and how they some times wish they were. 4. The cultural brand management process”—Actively engaging in the myth-making process making sure the brand maintains its position as an icon.

Recently a number of companies have successfully pursued “No-Brand” strategies, examples include the Japanese company Muji, which means “No label” in English (from [symbol] —“Mujirushi Ryohin”—literally, “No brand quality goods”). Although there is a distinct Muji brand, Muji products are not branded. This no-brand strategy means that little is spent on advertisement or classical marketing and Muji's success is attributed to the word-of-mouth, a simple shopping experience and the anti-brand movement.[9][10][11]

In this case the supplier of a key component, used by a number of suppliers of the end-product, may wish to guarantee its own position by promoting that component as a brand in its own right. The most frequently quoted example is Intel, which secures its position in the PC market with the slogan “Intel Inside”.

The existing strong brand name can be used as a vehicle for new or modified products; for example, many fashion and designer companies extended brands into fragrances, shoes and accessories, home textile, home decor, luggage, (sun-) glasses, furniture, hotels, etc.

Mars extended its brand to ice cream, Caterpillar to shoes and watches, Michelin to a restaurant guide, Adidas and Puma to personal hygiene. Dunlop extended its brand from tires to other rubber products such as shoes, golf balls, tennis racquets and adhesives.

There is a difference between brand extension and line extension. When Coca-Cola launched “Diet Coke” and “Cherry Coke” they stayed within the originating product category: non-alcoholic carbonated beverages. Procter & Gamble (P&G) did likewise extending its strong lines (such as Fairy Soap) into neighboring products (Fairy Liquid and Fairy Automatic) within the same category, dish washing detergents.

Alternatively, in a market that is fragmented amongst a number of brands a supplier can choose deliberately to launch totally new brands in apparent competition with its own existing strong brand (and often with identical product characteristics); simply to soak up some of the share of the market which will in any case go to minor brands. The rationale is that having 3 out of 12 brands in such a market will give a greater overall share than having 1 out of 10 (even if much of the share of these new brands is taken from the existing one). In its most extreme manifestation, a supplier pioneering a new market which it believes will be particularly attractive may choose immediately to launch a second brand in competition with its first, in order to pre-empt others entering the market.

Individual brand names naturally allow greater flexibility by permitting a variety of different products, of differing quality, to be sold without confusing the consumer's perception of what business the company is in or diluting higher quality products.

Once again, Procter & Gamble is a leading exponent of this philosophy, running as many as ten detergent brands in the US market. This also increases the total number of “facings” it receives on supermarket shelves. Sara Lee, on the other hand, uses it to keep the very different parts of the business separate—from Sara Lee cakes through Kiwi polishes to L'Eggs pantyhose. In the hotel business, Marriott uses the name Fairfield Inns for its budget chain (and Ramada uses Rodeway for its own cheaper hotels).

Cannibalization is a particular problem of a “multibrand” approach, in which the new brand takes business away from an established one which the organization also owns. This may be acceptable (indeed to be expected) if there is a net gain overall. Alternatively, it may be the price the organization is willing to pay for shifting its position in the market; the new product being one stage in this process.

With the emergence of strong retailers the “own brand”, a retailer's own branded product (or service), also emerged as a major factor in the marketplace. Where the retailer has a particularly strong identity (such as Marks & Spencer in the UK clothing sector) this “own brand” may be able to compete against even the strongest brand leaders, and may outperform those products that are not otherwise strongly branded.

Concerns were raised that such “own brands” might displace all other brands (as they have done in Marks & Spencer outlets), but the evidence is that—at least in supermarkets and department stores—consumers generally expect to see on display something over 50 percent (and preferably over 60 percent) of brands other than those of the retailer. Indeed, even the strongest own brands in the UK rarely achieve better than third place in the overall market.

This means that strong independent brands (such as Kellogg's and Heinz), which have maintained their marketing investments, are likely to continue their strong performance. More than 50 percent of UK FMCG brand leaders have held their position for more than two decades, although it is arguable that those which have switched their budgets to “buy space” in the retailers may be more exposed.

The strength of the retailers has, perhaps, been seen more in the pressure they have been able to exert on the owners of even the strongest brands (and in particular on the owners of the weaker third and fourth brands). Relationship marketing has been applied most often to meet the wishes of such large customers (and indeed has been demanded by them as recognition of their buying power). Some of the more active marketers have now also switched to ‘category marketing’—in which they take into account all the needs of a retailer in a product category rather than more narrowly focusing on their own brand.

At the same time, probably as an outgrowth of consumerism, “generic” (that is, effectively unbranded) goods have also emerged. These made a positive virtue of saving the cost of almost all marketing activities; emphasizing the lack of advertising and, especially, the plain packaging (which was, however, often simply a vehicle for a different kind of image). It would appear that the penetration of such generic products peaked in the early 1980s, and most consumers still appear to be looking for the qualities that the conventional brand provides.

Although connected with the history of trademarks[12] and including earlier examples which could be deemed “protobrands” (such as the marketing puns of the “Vesuvinum” wine jars found at Pompeii[13]), brands in the field of mass-marketing originated in the 19th century with the advent of packaged goods. Industrialization moved the production of many household items, such as soap, from local communities to centralized factories. When shipping their items, the factories would literally brand their logo or insignia on the barrels used, extending the meaning of “brand” to that of trademark.

Bass & Company, the British brewery, claims their red triangle brand was the world's first trademark. Lyle's Golden Syrup makes a similar claim, having been named as Britain's oldest brand, with its green and gold packaging having remained almost unchanged since 1885.

Cattle were branded long before this; the term “maverick”, originally meaning an unbranded calf, comes from Texas rancher Samuel Augustus Maverick who, following the American Civil War, decided that since all other cattle were branded, his would be identified by having no markings at all.

Factories established during the Industrial Revolution, generating mass-produced goods and needed to sell their products to a wider market, to a customer base familiar only with local goods. It quickly became apparent that a generic package of soap had difficulty competing with familiar, local products. The packaged goods manufacturers needed to convince the market that the public could place just as much trust in the non-local product. Campbell soup, Coca-Cola, Juicy Fruit gum, Aunt Jemima, and Quaker Oats were among the first products to be ‘branded’, in an effort to increase the consumer's familiarity with their products. Many brands of that era, such as Uncle Ben's rice and Kellogg's breakfast cereal furnish illustrations of the problem.

Around 1900, James Walter Thompson published a house ad explaining trademark advertising. This was an early commercial explanation of what we now know as branding. Companies soon adopted slogans, mascots, and jingles which began to appear on radio and early television. By the 1940s,[14] manufacturers began to recognize the way in which consumers were developing relationships with their brands in a social/psychological/anthropological sense.

From there, manufacturers quickly learned to build their brand's identity and personality (see brand identity and brand personality), such as youthfulness, fun or luxury. This began the practice we now know as “branding” today, where the consumers buy “the brand” instead of the product. This trend continued to the 1980s, and is now quantified in concepts such as brand value and brand equity. Naomi Klein has described this development as “brand equity mania”.[2] In 1988, for example, Philip Morris purchased Kraft for six times what the company was worth on paper; it was felt that what they really purchased was its brand name.

Marlboro Friday: Apr. 2, 1993—marked by some as the death of the brand[2]—the day Philip Morris declared that they were to cut the price of Marlboro cigarettes by 20%, in order to compete with bargain cigarettes. Marlboro cigarettes were notorious at the time for their heavy advertising campaigns, and well-nuanced brand image. In response to the announcement Wall street stocks nose-dived[2] for a large number of ‘branded’ companies: Heinz, Coca Cola, Quaker Oats, PepsiCo. Many thought the event signalled the beginning of a trend towards “brand blindness” (Klein 13), questioning the power of “brand value”.

A trademark or trademark is a distinctive sign or indicator used by an individual, business organization, or other legal entity to identify that the products or services to consumers with which the trademark appears originate from a unique source, and to distinguish its products or services from those of other entities.

A trademark is a type of intellectual property, and typically a name, word, phrase, logo, symbol, design, image, or a combination of these elements. There is also a range of non-conventional trademarks comprising marks which do not fall into these standard categories.

The owner of a registered trademark may commence legal proceedings for trademark infringement to prevent unauthorized use of that trademark. However, registration is not required. The owner of a common law trademark may also file suit, but an unregistered mark may be protectable only within the geographical area within which it has been used or in geographical areas into which it may be reasonably expected to expand.

The term trademark is also used informally to refer to any distinguishing attribute by which an individual is readily identified, such as the well known characteristics of celebrities. When a trademark is used in relation to services rather than products, it may sometimes be called a service mark, particularly in the United States.

A counterfeit product is an imitation which infringes upon a production monopoly held by either a state or corporation. Goods are produced with the intent to bypass this monopoly and thus take advantage of the established worth of the previous product. The word counterfeit frequently describes both the forgeries of currency and documents, as well as the imitations of clothing, software, pharmaceuticals, watches, electronics, and company logos and brands. In the case of goods it results in patent infringement or trademark infringement.

The spread of counterfeit goods (commonly called “knockoffs”) has become global in recent years and the range of goods subject to infringement has increased significantly. According to the study of Counterfeiting Intelligence Bureau (CIB) of the International Chamber of Commerce (ICC) counterfeit Goods make up 5 to 7% of World Trade, however, these figures cannot be substantiated.[1]. According to the International Anti-Counterfeiting Coalition if the knockoff economy were a business, it would be the world's biggest. [2] A recent report by the Organisation for Economic Co-operation and Development indicates that up to 200 Billion U.S. Dollars of international trade could have been in counterfeit and illegally-copied goods in 2005 (2% of World Trade in 2005)[3]

Some see the rise in counterfeiting of goods as an inevitable product of globalization. As more and more companies, in an effort to increase profits, move manufacturing to the cheaper labor markets of the third world, areas with weaker labor laws or environmental regulations, they give the means of production to foreign workers. These new managers of production have little or no loyalty to the original corporation. They see that profits are being made by the global brand for doing little (other than advertising) and see the possibilities of removing the middle men (i.e. the parent corporation) and marketing directly to the consumer.

Certain consumer goods, especially very expensive or desirable brands or those which are easy to reproduce cheaply have become frequent and common targets of counterfeiting. The counterfeiters either attempt to deceive the consumer into thinking they are purchasing a legitimate item, or convince the consumer that they could deceive others with the imitation. An item which doesn't attempt to deceive, such as a copy of a DVD with missing or different cover art, is often called a “bootleg” or a “pirated copy” instead.

Some counterfeits are produced in the same factory that produces the original, authentic product, using the same materials. The factory owner, unbeknownst to the trademark owner, orders an intentional ‘overrun’. Without the employment of anti-counterfeiting measures, identical manufacturing methods and materials make this type of counterfeit (and it is still a form of counterfeit, as its production and sale is unauthorized by the trademark owner) impossible to distinguish from the authentic article.

To try to avoid this, companies may have the various parts of an item manufactured in independent factories and then limit the supply of certain distinguishing parts to the factory that performs the final assembly to the exact number required for the number of items to be assembled (or as near to that number as is practicable) and/or may require the factory to account for every part used and to return any unused, faulty, or damaged parts. To help distinguish the originals from the counterfeits, the trademark holder may also employ the use of serial numbers and/or holograms etc., which may be attached to the product in another factory still.

Detection of counterfeit business names, slogans, and logos has required the assistance of expensive professionals such as marketing managers, brand experts, and trademark attorneys. Companies have not had an effective way to monitor their brands in an entirely globalizing world in which the counterfeiters can both create and market goods and services to consumers. Small company's have not had the resources to combat counterfeiters because they have not had the dedicated staff, expenses, and financial resources to employ monitoring services. Trademarkia.com has developed a unique methodology and algorithm to identify and flag counterfeiters to brands, both those of small companies and those of large companies, and offer these services to consumers through the world wide web for free.

The Trademarkia algorithm to identify counterfeit brands uses a multi-tier approach by employing a series of computer processors, each independently monitoring government filings in both state and federal domestic and international offices as well as active registrations of new domain names, websites, and indexed content on major search engines. By concatenating this information into one portal and using a n-tier development architecture, the concatenated data can be matched against and active or passive user request in a profile of the user. This may also enable interesting new search possibilities, such as the search and repurchase/reapplication of expired, abandoned, and/or otherwise no longer live trademarks by new applications. Prescreening technologies enable the system to generate unique search accuracies that build trust with users, according to one embodiment.

For example, a semantic database can be used to match the search term with other names/marks/slogans which might be confusingly similar. A match and count may be generated by cross referencing a potential mark on Twitter/Google to determine the search criteria's mark fame. This can help determine whether a likelihood of confusion or dilution test is to be used. Furthermore, a number of alternative techniques may be employed by allowing a simultaneous generation of possibly conflicting marks when a new mark is filed (e.g., either as a refilling of an abandoned trademark offered in a search result) or as an independent new filing.

In addition, opposition service windows may be adhered to by allowing users to find and oppose marks that are confusingly similar to theirs. Automated messages are sent through the system to address such conflicting marks to users so that they may oppose them electronically directly though the Trademarkia system according to one embodiment. As a result, the system and methods disclosed herein simplify the opposition processes. For example, an opposition may be enabled as a proceeding in which one party is seeking to prevent registration of another party's trademark when a user clicks an ‘oppose’ button accessible through a link in an electronic message submitted to a user through Trademarkia.

Trademarkia Previews Freshest, Easiest Way to Create a Brand at TechCrunch50. And it's Free.More than 5 million new logos, slogans, and trademarks searchable on Web for the First Time (www.trademarkia.com), the fresh, easy and intelligent way for people to create a brand, today previews its free service at TechCrunch50. Trademarkia was selected to demonstrate its product in TechCrunch50—a showcase of the world's hottest new startups—from among more than 1,000 applicants in 26 different countries.

Trademarkia is for busy people who want an effortless way to create a business name from the millions of trademarks filed at the United States Trademark Office that have now gone abandoned; receive email and SMS reminders and alerts on counterfeit brands; and find savings worth an average of $1,000 within minutes of use. People have really had only two ways to create a new brand in the past: come up with it on their own and hire a consultant. 6 million businesses in the U.S. need to create brands for their business, products, and services each year. Until Trademarkia, the option of creating a business name from abandoned names did not exist anywhere on the web because there was no way to find such names. Even when a good name for a brand was identified, verification of availability of a particular brand name required the assistance of expensive attorneys. What would the world be like if we couldn't “Google” information we did not already know? Such a world may have been our fate, had the prior holders of that mark not abandoned their ownership of it. Until Trademarkia, once fledging startups such as Google, Twitter, and Yelp (all previously owned brands) had to rely on expensive attorneys to find out whether previously expired brands were in fact available for purchase.

Startup entrepreneur and intellectual property attorney Raj Abhyanker considered these things when creating Trademarkia. “Trademarkia is essentially creating a market in which abandoned business names can be recycled similar to the now $1 billion+ expired domain industry.” Trademarkia exposes the millions of historical business names, slogans and logos since the year 1870 that have now gone abandoned and makes them available for re-registration.

Trademarkia is the free, easy and intelligent way to create and manage brands online

Trademarkia is designed to be virtually effortless for the user. It applies a patent-pending technology and proprietary algorithms to compile business name data from all available sources into a single, easy-to-use and uniquely powerful online business name search engine. In addition, Trademarkia also offers a valuable service to businesses looking to protect the brands they already own. Trademarkia enables businesses, both large and small, to keep an eye on their competitors who try to file trademarks, domain names, and start websites which are confusingly similar to the brands that they worked hard to build and protect. Users simply indicate the brands that they want to monitor, and can receive free online reports and updates on activities of counterfeiters.

Trademarkia.com has been in private beta testing for the past few months, and is generating highly enthusiastic responses from early users. Trademarkia's management and engineering team is comprised of experts in Web technology, brand management and intellectual property. Trademarkia's product and market potential have attracted investment interest from both the venture and angel communities. “This is a great product! It is fun to find interesting brands on Trademarkia that can help my small business succeed,” said Colette Pierre, a Trademarkia private beta user. “I recently registered my brand as a federal trademark, and it is important to the long term success of our small business to be able to monitor against companies trying to steal our goodwill. Trademarkia makes that process easy, and has already saved our company money.”

Founded in March 2009, Trademarkia.com is the fresh, easy and intelligent way for people to create their brands from millions of previously owned business names, slogans, and logos. And it's free.

Patent-pending Trademarkia technology does all the rest, giving users a unified view of all their brands in a single, easy to understand interface. Trademarkia provides detailed visibility into expired and abandoned business names, slogans, and logos; proactively alerting users about upcoming issues, counterfeit marks; and offering personalized suggestions for interesting brands. The service is accessible via the Web or cell phone. And it's safe and secure; Trademarkia is updated every day with fresh data, and offers secondary checking services to users.

For more information on Trademarkia.com's free business name creation service, please visit www.trademarkia.com.

The Figures that this disclosure contemplates include a system view of a computing device, according to one or more embodiments. In one or more embodiments, a computing device may include a display unit and a display driver associated with the display unit that performs the methods disclosed herein of automatically detecting counterfeit brands.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Accordingly, the specification and drawings are to be regarded in an illustrative rather than a restrictive sense.

Problem Space

Effective marketing is essential to any business, corporation, university, institution, and/or individual and is generally referred to as the most important aspect of any business strategy. Large companies may spend millions of dollars to hire reputed agencies to handle the marketing of their business whereas smaller companies may rely on more creative and cost efficient methods. In the extremely competitive world of today's business environments, social media marketing may be the new ‘in’ thing and may be here to stay. In a nutshell, it may mean using social media such as blogs, community sites, video sharing sites etc. to market a product or a business.

Social media are media for social interaction, and may use highly accessible and scalable publishing techniques. Social media may use web-based technologies to transform and/or broadcast media monologues into social media dialogues. Social media may also be a group of Internet-based applications that build on the ideological and technological foundations of a technology called Web 2.0, and that may allow the creation and exchange of user-generated content. Businesses may also refer to social media as consumer-generated media (CGM). A common thread running through all definitions of social media is a blending of technology and social interaction for the co-creation of value.

Certain popular websites like LinkedIn, Facebook, Twitter, Flickr and YouTube which have more than five million visitors everyday may be considered to be an important hub for online marketing. Promoting one's business using these sites may be a very attractive business proposition since they may traditionally offer a huge amount of steady traffic every day. In today's world, social networking will likely be extremely successful and social media marketing may turn out to be very important to any business, corporation, university, institution, and/or individual because of the sheer number of people that access these sites regularly.

The reasons why this type of marketing may be so important, or rather, essential for a business are many. First, it may be a low cost investment when compared to the other options available, and may offer many links to one's site for free. Social media is generally free to use but marketing the same thing through conventional methods may cost thousands of dollars. Social media sites get a lot of traffic and they in turn they may generate traffic to one's site. Also they may act like a word-of-mouth concept that people may tend to believe when compared to commercial advertising. To make a lasting impact on the user and build a successful business any entrepreneur should be adept in social media marketing. Marketing through social media may be a potent method that may make one's business profitable.

Several companies use social media to their advantage. For example, Dell, the Texas-based computer giant has created three photo streams on Flickr, 26 pages and groups on Facebook and 34 Twitter feeds. These include a Facebook page for “US Consumer Dell Deals,” a Facebook Fan group entitled “I support Dell for choosing Ubuntu Linux,” and Twitter feeds offering special deals to small businesses. Dell isn't alone. Many other well-known companies are pursuing the marketing opportunities offered by social media. Ford, Target, Coca-Cola and Pepsi are some of the businesses on Facebook. United Airlines, Hotwire, and CNN are among those with Twitter feeds.

Considering the importance of social media, it is no surprise that social media may also pose trademark worries for businesses, particularly in the areas of brand management and dilution. Companies, businesses, and/or celebrities may be at risk of some imposter taking their identity. Sometimes this may involve out-and-out theft; other times it may be a case of mistaken identity with no fault of the imposter.

For example, both Delta Airlines and Delta Faucet may have legitimate claims to the social media domain address of www.facebook.com/delta. The trademark issues may be similar, but the law isn't. There are clear rules and legal procedures for resolving cyber squatting and other domain name disputes, but the law hasn't yet caught up to social media—which in essence are domain names that may be more important and crucial to protect than traditional name based domain names.

If a domain name makes unauthorized use of a company's trademark—for instance, if www.dell.com was to be registered by a competitor—there are powerful legal remedies. The Uniform Domain-Name Dispute-Resolution Policy (UDRP) enables the mark's owner to bring the matter to an arbitrator for a quick resolution of the dispute. The arbitrator may award the domain name to the trademark owner if that owner can prove three things: The domain name is identical or confusingly similar to the owner's trademark; the current owner of the domain name has no right to or legitimate interest in the domain name; and the current owner of the domain name has registered and is using it in bad faith.

A trademark owner in the U.S. may also seek relief under the Anti cyber squatting Consumer Protection Act. This federal statute creates liability for any entity that, “with a bad faith intent to profit from the goodwill of another's trademark,” registers or uses a domain name that is either identical or confusingly similar to a mark that is distinctive at the time the domain name is registered; or identical, confusingly similar to, or dilutive of a trademark that is famous at the time the domain name is registered.

The trademark owner can also get either actual damages or statutory damages of between $1,000 and $100,000 per domain name. Unfortunately, neither of these legal remedies may help protect trademark owners in the realm of social media. Therefore, at present, there exists no effective way for brand owners to protect themselves in the world of social media.

What is claimed is:

1. A method to simultaneously reserve online brand identity comprising:
initiating a simultaneous search responsive to a single criteria;
creating a uniform search result of available internet property such as trademark names, domain names, and/or social media names;
searching availability of the internet property related to single search criteria;
retaining ownership of matching internet property;
registering the internet property;
presenting opportunity to users to challenge ownership of the internet property.

2. The method of claim 1, wherein abandoned trademarks responsive to a single search criteria are automatically registered.

3. The method of claim 1, wherein semantic analysis is performed on search results from the single search criteria.

4. A system comprising:
a processor; and
a computer readable storage medium having computer readable instructions stored thereon for execution by the processor, forming the following automated software algorithm modules:
(a) a trademark registrar module to search and analyze XML feeds comprising data of trademark filings for one or more word marks;
(b) a domain registrar module to automatically search available domain names on the internet based on a trademark filing for a word mark;
(c) a social media registrar module to automatically search one or more online social media sites based on a trademark filing for a word mark;
(d) a page module that automatically creates a pre-populated page with the results from the domain name search module and/or social media name search module; and
(e) a register module that automatically reserves an available domain name and/or social media name based on a trademark filing for a word mark.

5. The system of claim 4, wherein the trademark registrar module analyzes one or more feeds of XML data containing information of new trademark filings for one or more word marks.

6. The system of claim 5, wherein the trademark registrar module searches one or more periodic feeds of XML data and gathers XML data containing information of one or more abandoned trademarks.

7. The system of claim 6, wherein the trademark registrar module analyzes whether one or more of the abandoned trademarks of claim 3 are confusingly similar to one or more marks in the same trademark classification.

8. The system of claim 7, wherein the trademark registrar module analyzes whether one or more of the abandoned trademarks of claim 3 are confusingly similar to one or more marks in one or more trademark classifications.

9. The system of claim 8, wherein the trademark registrar module searches a common law database to analyze whether one or more of the abandoned trademarks of claim 3 are confusingly similar to one or more common law trademark.

10. The system of claim 4, wherein the domain registrar module automatically searches available domain names on the internet based on one or more abandoned trademarks.

11. The system of claim 10, wherein the social media registrar module automatically searches available social media names on the internet based on one or more abandoned trademarks.

12. The system of claim 11, wherein the page module automatically creates a pre-populated page with the results from the domain name search module.

13. The system of claim 12, wherein the page module automatically creates a pre-populated page with the results from the social media name search module.

14. The system of claim 13, wherein the one-click register module automatically reserves an available domain name based on one or more abandoned trademarks.

15. The system of claim 14, wherein the one-click register module automatically reserves an available social media domain name based on one or more abandoned trademarks.

16. The system to automatically edit a logo so that it may be trademarked comprising:
a processor; and
a computer readable storage medium having computer readable instructions stored thereon for execution by the processor, forming the following automated software algorithm modules:
(a) a trademark logo module to search and analyze one or more feeds of XML data comprising data of trademark filings for one or more logo marks;
(b) a logo search module to analyze whether a given logo is confusingly similar to one or more logos gathered by the trademark logo module;
(c) a logo edit module to edit a logo so that it may not be confusingly similar to one or more logos from the trademark logo module.

17. The system of claim 16, wherein the logo edit module changes the color of a given logo so that it may not be confusingly similar to one or more logos analyzed by the trademark logo module.

18. The system of claim 17, wherein the logo edit module changes the resolution of a given logo so that it may not be confusingly similar to one or more logos analyzed by the trademark logo module.

19. The system of claim 4, wherein the trademark filing module automatically tags the data from one or more feeds of XML data based on office actions related to one or more trademark applications.

20. The system of claim 19, wherein the trademark filing module automatically prepares a template response based on office actions related to one or more trademark applications.

21. A method to determine the availability of social media domains based on a trademark filing comprising:
implementing an automated software algorithm to search and analyze one or more XML feeds containing data of new trademark applications;
searching for available domain names and social media names on the Internet based on trademark filing data gathered from the one or more XML feeds;
creating a pre-populated search page based on the results from the domain name search and/or the social media name search; and
automatically registering an available domain name and/or a social media name with a single click.

22. The method of claim 21, wherein changes to a company's stock price as a result of a trademark filing may be reflected in a unique pre-populated page.
